(19) United States
(12) Patent Application Publication
(10) Pub. No.: US 2019/0225310 A1
(43) Pub. Date: Jul. 25, 2019

(54) NESTING FENDERS

(71) Applicant: Contact Left, LLC, Seattle, WA (US)

(72) Inventors: John D. Denney, JR., Seattle, WA (US); Eoin J. Dunstan, Bainbridge Island, WA (US); Robert G. Carrasca, Seattle, WA (US); Christopher R. Hamlin, Seattle, WA (US); Kathryn Crabb, Seattle, WA (US); Dylan Piper-Kaiser, Seattle, WA (US)

(73) Assignee: Contact Left, LLC, Seattle, WA (US)

(21) Appl. No.: 16/364,216

(22) Filed: Mar. 26, 2019

Related U.S. Application Data
(63) Continuation-in-part of application No. 15/633,605, filed on Jun. 26, 2017, now Pat. No. 9,873,493.
Application No. 15/633,605 is a continuation-in-part of application No. 15/862,276, filed on Jan. 4, 2018, now Pat. No. 10,239,594.
(60) Provisional application No. 62/443,738, filed on Jan. 8, 2017.
(60) Provisional application No. 62/492,852, filed on May 1, 2017.

(51) Int. Cl. B63B 59/02; E02B 3/26; F16F 3/087

(52) U.S. Cl. CPC B63B 59/02; E02B 3/26; F16F 2224/02; F16F 2224/0225; F16F 2224/025; F16F 3/0876

(57) ABSTRACT

An arrangement of fenders nested together for compact storage, the fenders including two or more cylindrical bodies having a cavity accessed through the fender top, the fenders being similar shape but graduated in size such that the cavity of a larger fender tensionally receives the next smaller sized fender, the outer diameter of the smaller fender equal to the inner diameter of the larger fender cavity. A fender has a rigid inner core surrounded by a compressible shell made of foam or similar material. The inner core has attachment points for a rope or line. The smallest nesting fender in the set has a cavity diameter sized to fit a commercially-available, off-the-shelf fender. The fenders may be separated and deployed at individual locations on a vessel, or kept together and deployed as a single fender capable of absorbing a greater impact than any of the fenders individually would absorb.

### PRIORITY CLAIM

The present application is related to and/or claims the benefits of the earliest effective priority date and/or the earliest effective filing date of the below-referenced applications, each of which is hereby incorporated by reference in its entirety, to the extent such subject matter is not inconsistent herewith, as if fully set forth herein:

(1) this application constitutes a non-provisional of U.S. Provisional Patent Application No. 62/443,738, entitled NESTING FENDERS, naming John D. Denney as the inventor, filed Jan. 8, 2017, with attorney docket no. CNTC-1-1002, which is currently co-pending or is an application of which a currently co-pending application is entitled to the benefit of the filing date;

(2) this application constitutes a non-provisional of U.S. Provisional Patent Application No. 62/492,852, entitled NESTING FENDERS, naming John D. Denney, Jr. as the inventor, filed May 1, 2017, with attorney docket no. CNTC-1-1002-1, which is currently co-pending or is an application of which a currently co-pending application is entitled to the benefit of the filing date;

(3) this application constitutes a continuation-in-part of U.S. patent application Ser. No. 15/633,605, entitled NESTING FENDERS, naming John D. Denney, Jr., Robert Carrasca, and Christopher Hamlin as the inventors, filed Jun. 26, 2017, with attorney docket no. CNTC-1-1002-2, and issuing on Jan. 23, 2018 as U.S. Pat. No. 9,873,493, which is currently co-pending or is an application of which a currently co-pending application is entitled to the benefit of the filing date; and

(4) this application constitutes a continuation-in-part of U.S. patent application Ser. No. 15/862,276, entitled NESTING FENDERS, naming John D. Denney, Jr., Robert Carrasca, and Christopher Hamlin as the inventors, filed Jan. 4, 2018, with attorney docket no. CNTC-1-1002-3, which is currently co-pending or is an application of which a currently co-pending application is entitled to the benefit of the filing date.

### FIELD OF THE INVENTION

This invention relates generally to marine vessels such as boats and fenders for them, and, more specifically, to nesting fenders.

### BACKGROUND OF THE INVENTION

In boating, a fender is a bumper used to absorb the kinetic energy of a boat or vessel berthing against a jetty, quay wall or other vessel. Fenders are used to prevent damage to boats, vessels and berthing structures. Contemporary “rubber” fenders evolved from commercial fishing buoys at least in the 1970's, and have not significantly changed. Primarily they are inflatable bladders in a shape of a ball or cylinder. They are difficult to store and require significant space. Inflatable designs exist but require additional effort to inflate and deflate in conjunction with their use and storage. Accordingly, a need exists for fenders which require less storage than the typical fender without requiring inflation mechanisms to be carried on board the vessel.

### DESCRIPTION OF RELATED ART

U.S. Pat. No. 3,145,686 issued to John B. Blythe on Mar. 29, 1963 discloses a combination boat bumper and container. Blythe does not specifically discuss storing a smaller bumper within the containment section of a larger bumper.

U.S. Pat. No. 3,286,680 to Robert Caretta on Jul. 20, 1965 discloses a plurality of cylindrical fenders in which an annular cavity having an aperture at a bottom portion of a first fender may receive an upper hemispherical portion of a second, equally-sized fender for the purpose of creating a very long, singular fender. Caretta does not disclose differently-sized fenders so that a first fender may receive an entirety of a second, smaller fender for storage of the second fender.

U.S. Pat. No. 6,357,377 to Albert Santelli, Jr. on Mar. 19, 2002 discloses a fender having a stacked arrangement of pleated sections which collapses vertically to form a compact article for storage. Santelli does not disclose an arrangement where an entire fender may fit within another fender for optimally-reduced storage requirements.

WIPO Patent Application Publication No. WO 2013/020910, submitted on behalf of Matteo Gencarelli and published on Feb. 14, 2013, discloses a segmented boat fender in which a plurality of tubular members of graduated diameter but constant height can be extended telescopically to form a marine fender and can be collapsed for storage with all but one of the tubular members fitting inside the member having the largest diameter. Gencarelli does not teach the individual tubular members being deployable as an individual boat fender.

U.S. Pat. No. 5,184,745 to Petrina Havens on Feb. 9, 1993 is an example of a disclosure of a plurality of containers which are nestable to conserve storage space. A number of such disclosures exist in the relevant technology area. None of said disclosures teach nesting of a plurality of graduated-sized containers that are suitable for absorbing kinetic energy resulting from two objects forcefully coming together.

### SUMMARY

The instant application discloses a plurality of fenders of graduated size, each of which has a cavity for receiving the next smaller sized fender for storage. The fenders are suitable for use in a marine environment and are constructed to absorb the kinetic energy resulting from a boat berthing against a dock, another boat, or similar object. The fender has a cylindrical body including a stiff, cylindrical inner core that is surrounded by a softer outer shell which compresses upon impact. A pliable material may cover the exterior of a nesting fender for protection of the fender from the harsh marine environment. The cavity for receiving other fenders for storage is also cylindrical and is accessible through an aperture in the top of the fender. A smaller aperture through the bottom of the fender is disposed through an interior flange of the outer shell, the interior flange defining a lip upon which the next-sized down fender rests when nested inside the cavity. A rope or line may be attached to the inner core via a grommet or other attachment point on the inner core, which provides a more robust attachment point than would be possible with an attachment of the rope to the softer outer shell that may be constructed of foam or similar compressible material.

The relative diameters of the graduated-sized fenders are such that the inner diameter of the cylindrical cavity of a larger fender is substantially the same as the outer diameter of the next sized down fender. The diameters are sized to provide tension between the outer surface of the cylindrical body of the smaller fender and the inner surface of the cylindrical cavity of the larger fender for retention of the smaller fender within the larger fender. The tension provided is such that the fenders will remain nested when at rest or even when displaced by the boat in motion (e.g. if the nested fenders are upside-down) but without so much tension that the fenders are unable to be nested or separated by hand. In addition to providing the tension for keeping the fenders nested, the relative diameters ensure that the entire cavity of the larger fender is utilized by the smaller fender with no wasted interior space, maximizing the storability of the nested fenders. The smallest nesting fender of the set may be sized to receive a commercially-available off-the-shelf fender of the type that does not have an interior cavity, such as an F Series fender manufactured by Polyform US (an example of which is viewable on the World Wide Web at www.polyformus.com/boat-fenders/f-series), ensuring that every volumetric portion of the cavity of the largest fender is used for other fenders and optimizing storability.

The resulting differently-sized fenders are deployable about the boat for different purposes. For example, the largest fenders may be deployed along a side of the boat adjacent to an immovable jetty, and smaller fenders may be deployed along an opposing side of the boat adjacent to another boat floating in the water. In this way, the fenders may be deployed to optimally absorb the relative impact of the adjacent bodies. The largest fenders, which are capable of absorbing the most impact force, can be placed nearest the immovable object (e.g. a jetty) where impact forces are likely to be largest. Smaller fenders, which can absorb relatively less impact force, are placed nearest to floating objects like other boats where impact forces are likely to be lessened because some energy from impact is consumed by the rebound of the other boat subsequent to impact. In a different usage, the fenders may be deployed in a nested configuration (i.e. a smaller fender within a larger fender) to provide an even stronger unit which is capable of absorbing a relatively larger impact than a single nesting fender acting alone.

The foregoing is a summary and thus contains, by necessity, simplifications, generalizations and omissions of detail; consequently, those skilled in the art will appreciate that the summary is illustrative only and is not intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIG. 1a is an exploded view of a pair of nested fenders.

FIG. 1b is an isometric view of a pair of nested fenders in which a smaller fender is nested inside a cavity of a larger fender.

FIG. 1c is a cross-sectional view of the pair of nested fenders in which the smaller fender is nested inside the cavity of the larger fender.

FIG. 1d is a close-up view of a portion of the cross-section depicted in FIG. 1c.

FIGS. 2a-2d are a top view, a side view, a bottom view, and a front view of a nesting fender.

FIG. 3a is a cross-sectional view of the cylindrical body of a nested fender showing the rigid inner core surrounded by the compressible outer shell.

FIG. 3b is a cross-sectional view of the cylindrical body of the nested fender from the same perspective as that of FIG. 3a, but with the rigid inner core not shown to bring the hollow within the compressible outer shell into view.

FIG. 3c is a perspective view of the rigid inner core.

FIG. 4a is a perspective view of a prior art commercially-available, off-the-shelf marine fender.

FIG. 4b is a perspective view of a nesting fender arrangement in which the smallest nesting fender has received a commercially-available, off-the-shelf marine fender.

FIG. 5a is a perspective view of a nesting fender.

FIG. 5b is an exploded view of a nesting fender.

FIG. 5c is a perspective view of a length of rope disposed through a tensioning device.

FIG. 6a is a perspective view of a segment of a nesting fender.

FIG. 6b is a top view of a segment of a nesting fender.

FIG. 6c is a cross-sectional view of a segment of a nesting fender.

FIG. 7a is a perspective view of a connector of a nesting fender.

FIG. 7b is a top view of a connector of a nesting fender.

FIG. 7c is a cross-sectional view of a connector of a nesting fender.

FIG. 8a is a top perspective view of an endcap of a nesting fender.

FIG. 8b is a top view of an endcap of a nesting fender.

FIG. 8c is a bottom perspective view of an endcap of a nesting fender.

FIG. 8d is a bottom view of an endcap of a nesting fender.

FIG. 8e is a cross-sectional view of an endcap of a nesting fender.

FIG. 9a is a partially exploded perspective view of a portion of a nesting fender and portions of battens.

FIG. 9b is a top view of a nesting fender and portions of battens.

FIG. 9c is a partially exploded perspective view of a portion of a nesting fender and portions of battens.

### DETAILED DESCRIPTION

Specific details of certain embodiments of the invention are set forth in the following description and in the figures to provide a thorough understanding of such embodiments. The present invention may have additional embodiments, may be practiced without one or more of the details described for any particular described embodiment, or may have any detail described for one particular embodiment practiced with any other detail described for another embodiment.

Importantly, a grouping of inventive aspects in any particular “embodiment” within this detailed description, and/or a grouping of limitations in the claims presented herein, is not intended to be a limiting disclosure of those particular aspects and/or limitations to that particular embodiment and/or claim. The inventive entity presenting this disclosure fully intends that any disclosed aspect of any embodiment in the detailed description and/or any claim limitation ever presented relative to the instant disclosure and/or any continuing application claiming priority from the instant application (e.g. continuation, continuation-in-part, and/or divisional applications) may be practiced with any other disclosed aspect of any embodiment in the detailed description and/or any claim limitation. Claimed combinations which draw from different embodiments and/or originally-presented claims are fully within the possession of the inventive entity at the time the instant disclosure is being filed. Any future claim comprising any combination of limitations, each such limitation being herein disclosed and therefore having support in the original claims or in the specification as originally filed (or that of any continuing application claiming priority from the instant application), is possessed by the inventive entity at present irrespective of whether such combination is described in the instant specification because all such combinations are viewed by the inventive entity as currently operable without undue experimentation given the disclosure herein and therefore that any such future claim would not represent new matter.

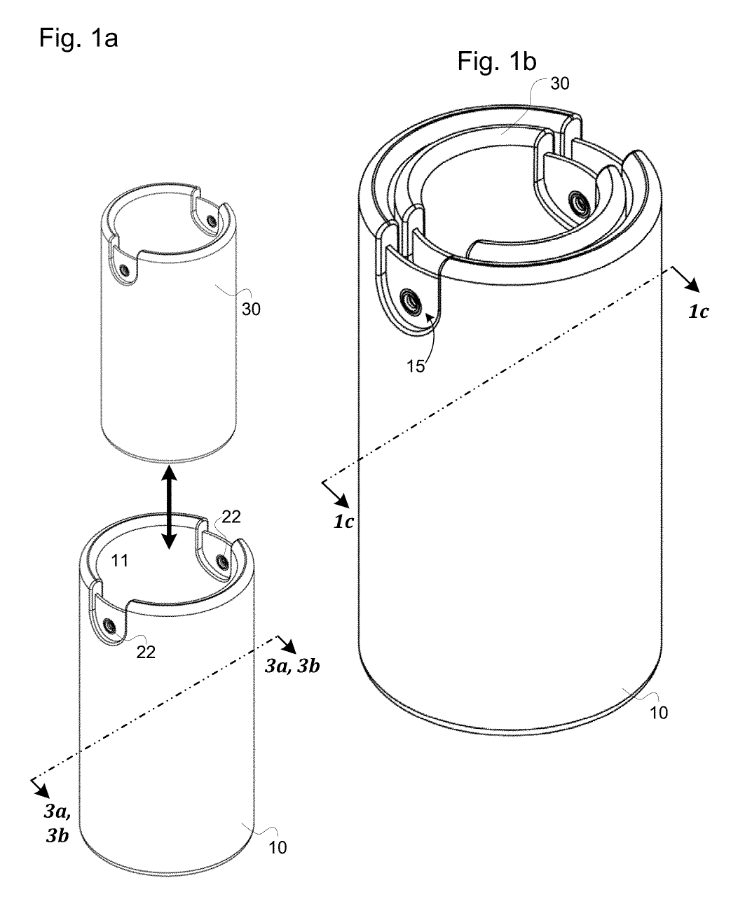

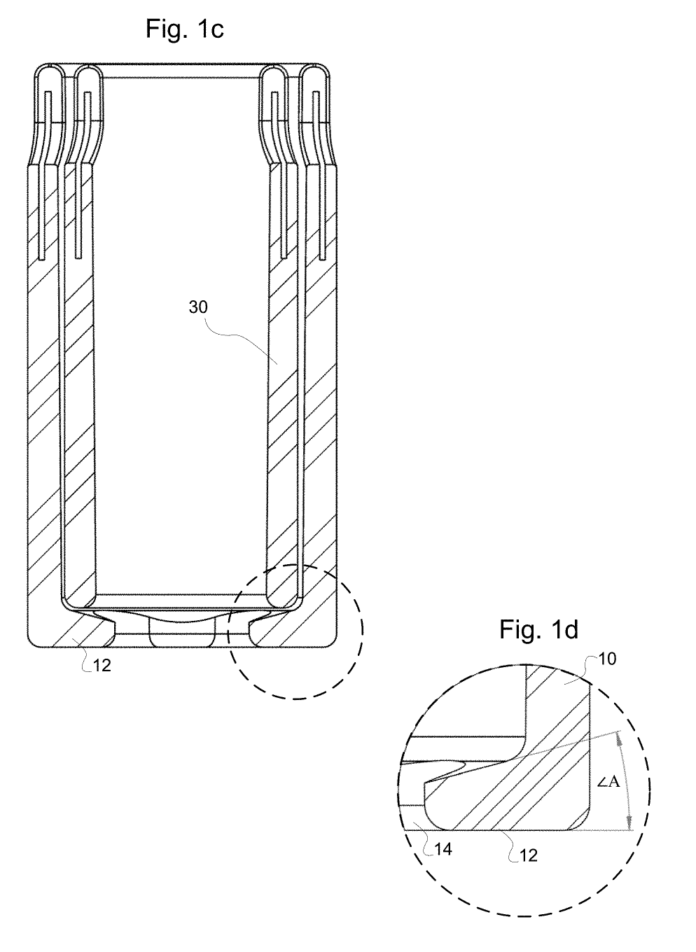

A pair of nesting fenders is shown in FIGS. 1a-1c, including a larger fender 10 and a smaller fender 30. Two fenders, a larger fender (a first fender, e.g.) and a smaller fender (at least one other fender, e.g.), are depicted throughout the drawings. It will be understood that an arrangement of nesting fenders is not limited to two fenders, and that three, four, five or another larger number of nesting fenders are all envisioned as possible embodiments. For clarity of the drawings and a compact presentation of the invention, only two fenders are shown. While the fenders are depicted as separated in FIG. 1a, the fenders are shown nested in FIGS. 1b and 1c with the smaller fender having been inserted into a cavity of the larger fender 11. Nesting a smaller fender inside the cavity of the larger fender involves placing the bottom of the smaller fender into the aperture through the top surface of the larger fender and pressing the smaller fender down until the smaller fender comes to rest on a flange of the larger fender 12. An attachment point 15 is present for a line or a rope (not shown) to be coupled with the fender. A grommet 22 may be disposed through the attachment point. The fender arrangement is sized such that the height of a smaller fender is received by the interior cavity of the larger fender in its entirety. The smaller fender is substantially the same height as, or less than, the height of the larger fender less the height of the flange of the larger fender. FIG. 1d is a close-up of a cross-section of the larger fender 10. The flange 12 may include a slope which, when the nesting fenders are at rest in a vertical orientation, facilitates drainage of water through the aperture 14. The slope is depicted as ∠A in FIG. 1d and may be a 15 degree slope from the horizontal, or may be another suitable angle.

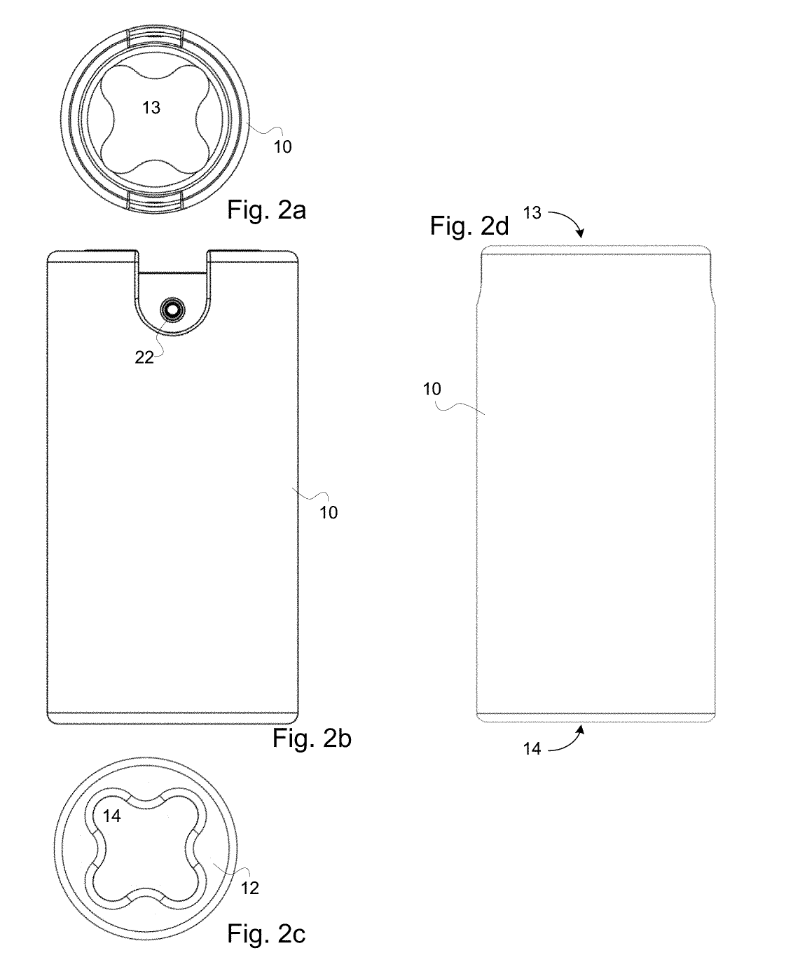

Turning to FIGS. 2a-2d, it may be seen that a nesting fender 10 has a cylindrical body, with an aperture through the top of the cylindrical body 13 and another aperture through the bottom of the cylindrical body 14. The aperture through the top of the cylindrical body leads to the cavity for receiving a smaller fender, which has an annular (i.e. cylindrical) shape with an inner diameter that is substantially the same as the outer diameter of the next-smallest size fender. The diameter of the aperture through the top of the cylindrical body is thus the same as the inner diameter of the cavity. The aperture through the bottom surface of the cylindrical body is disposed through the aforementioned flange 12. The portion of flange meeting the cylindrical body presents a shelf on which the fender inserted into the cavity rests. The flange also strengthens the bottom section of the fender through making it more crush-resistant, yet has a lobed design to prevent excess rigidity of the fender. As discussed previously, the aperture through the flange permits water to pass through the bottom surface of the fender, preventing the fender from filling with water which would make the fender heavy. A grommet 22 for a line or a rope is disposed within a channel through a portion of the cylindrical body. The fender may have one, two or more grommets and/or attachment points.

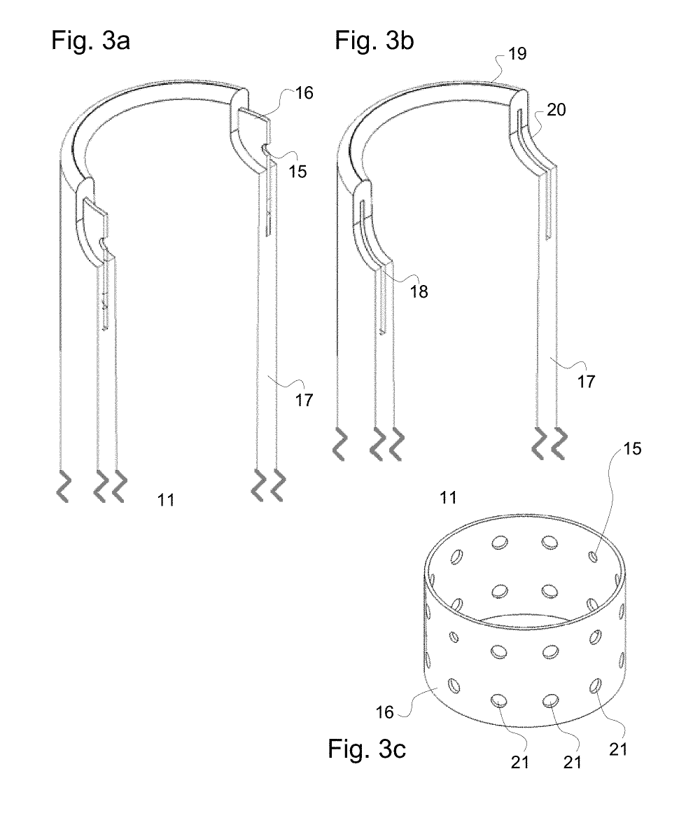

FIG. 3a presents a cross-sectional view of a fender depicting the rigid inner core 16 and the compressible outer shell 17. FIG. 3b presents a cross-sectional view of the fender from the same perspective as that of FIG. 3a, but with the rigid inner core not shown to bring the hollow within the compressible outer shell 18 into view. (The bottom portions of the fender are not shown in the cross-sectional views of FIGS. 3a and 3b.) The rigid inner core is disposed within the hollow of the compressible outer shell, nearest the top portion of the cylindrical body of the fender. A top rim 19 of the compressible outer shell has a portion cut away from the rim to expose a portion of the rigid inner core. Through this cutout 20, the channel 15 which defines the attachment point for a rope or line, into which a grommet may be disposed, is accessible.

Turning to FIG. 3c, it may be seen that the rigid inner core has a plurality of holes 21 which act to create tension between the rigid inner core and the compressible outer shell, biasing the rigid inner core against rotating axially or spinning within the hollow of the compressible outer shell. The channel 15 through the wall of the rigid inner core defines the attachment point. As previously stated, one, two or more attachment points may be present within the rigid inner core and accessible via cutouts in the compressible outer shell. The rigid inner core may be fabricated from rubber or a hard plastic material or be polymerized to assure durability of the core, and to provide a more suitable attachment point via the channel through the wall of the core. A grommet (not shown in FIG. 3c but which may be seen in FIGS. 1a, 1b, 2a, and 2b) may be used at attachment point 15 to reinforce the channel cut through the rigid inner core that provides the attachment point. Where two attachment points are present (i.e. two channels cut through the rigid inner core providing the two attachment points), they may be disposed on opposing sides of the rigid inner core and adjacent to the upper rim of the rigid inner core.

The compressible outer shell is fabricated with foam or similar material. As previously mentioned, the inner diameter of the interior cavity 11 of the compressible outer shell is substantially the same as the outer diameter of the compressible outer shell of the next-smallest sized fender. “Substantially the same” may mean exactly the same, or mean within a reasonable manufacturing tolerance for foam articles (e.g. +/−0.1 inches), or may mean that the outer diameter of the smaller fender is slightly larger than the interior cavity inner diameter of the larger fender such that the compressible outer shells of the smaller and larger fenders compress slightly in order to frictionally insert and retain the smaller fender within the larger fender by hand.

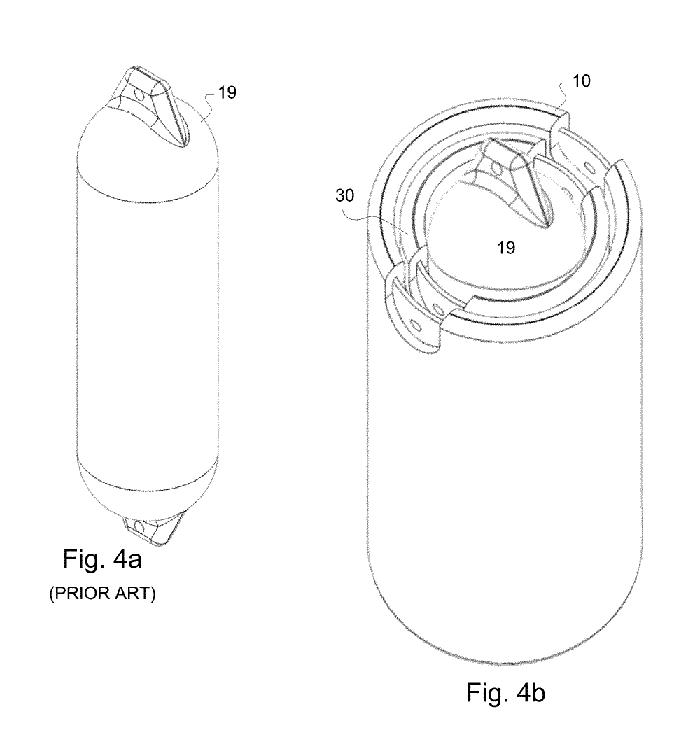

Turning to FIGS. 4a and 4b, as previously mentioned, a prior-art commercially-available, off-the-shelf (COTS) fender 19, such as a Polyform F-series fender, may be used in concert with the nesting fender arrangement to provide even better maximization of space utilization. That is, the smallest nesting fender 30 of the nesting fender arrangement may be constructed such that the inner diameter of the interior cavity is sized to be substantially the same as the outer diameter of the cylindrical COTS fender. The inner diameter of the smallest nesting fender may otherwise be slightly smaller than the outer diameter of the cylindrical COTS fender so as to compress slightly when the COTS fender is inserted so as to tensionally retain the COTS fender. The COTS fender may be an inflatable fender since deflation of the fender is not necessary for its storage as the interior cavity of the smallest nesting fender is already sized perfectly to receive the COTS fender. The COTS fender, upon being inserted into the nested fender(s), rests upon the sloped portion of the flange.

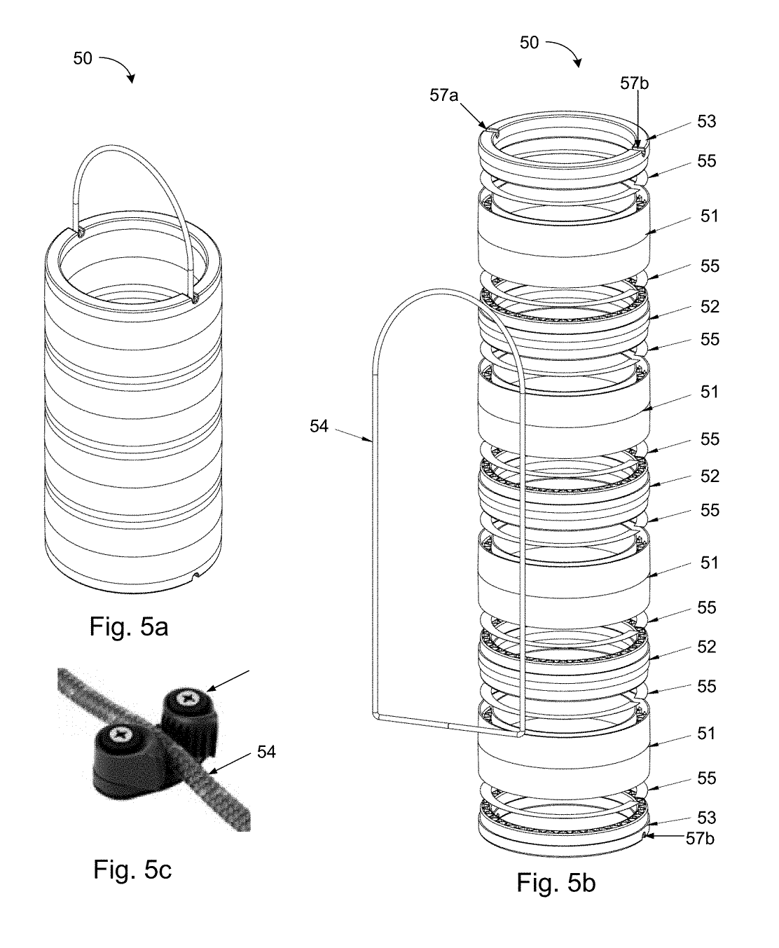

Turning to FIGS. 5a and 5b, a nesting fender 50 may be constructed of a plurality of segments 51, connectors 52, endcaps 53, and a rope 54. It will be seen that the segments, connectors and endcaps are capable of holding together via frictional tension, through adhesion provided by an adhesive substance applied in between the segments during manufacturing and/or through compression provided by the rope in combination with an optional rope tensioning device.

At least two passages are disposed through each of the segments, connectors and endcaps, the at least two passages being located to align with the passages of adjoining elements. As a nesting fender is formed when the segments, connectors and endcaps are brought together with the passages aligned, at least two rope channels disposed from a top of the nesting fender to the bottom of the nesting fender are created. The rope is passed through the first rope channel and through the other rope channel(s) and the two ends of the rope can then be joined, creating a continuous loop of rope through the fender.

Alternatively, or in addition to the aforementioned manners of holding the segments, connectors and endcaps together, an adhesive such as film ring 55 or other adhesive compounds may be placed between endcaps and segments, and between connectors and endcaps, to bond (or further bond) those elements together. The adhesive may have holes alignable with the channels in the segments, connectors and endcaps for passage of the rope through the rope channels.

As will be discussed below, it will be seen that the endcaps may be omitted from the construction of the fender. Also, it is observed that the construction of the fender permits fenders of differing heights to easily be specified, constructed and distributed. Taller fenders may be manufactured by adding additional segments and connectors. Shorter fenders use fewer segments and connectors. The fenders may be assembled and adhered to reach a certain height in manufacturing. Alternatively, the fenders can be offered to consumers as a kit including unassembled segments, connectors, endcaps, adhesive film rings and rope, enabling a consumer to select the desired height for the fenders, select a corresponding number of elements and easily couple those elements at the consumer's location to obtain a fender of the desired height subsequent to purchase of the kit.

An excess length of rope (i.e. a length of rope more than would be needed if the rope were passed through the at least two rope channels and pulled tight to compress the segments, connectors and endcaps together before the ends were joined, with any slack being cut from the rope) is left in place, providing some slack in the rope which may form a loop above the top of the fender. The foregoing loop in the rope is used for coupling to a tie line from the boat or for providing a handle for carrying a nesting fender (or multiple fenders that have been nested). The tie line and nesting fender rope loop may be coupled via tying the two together, or by using a carabiner or other suitable coupling. The slack may be pulled through one or any of the rope channels from one end of the fender to the other, moving the loop at which the tie line is coupled to the fender to the opposing end of the fender, enabling the top and bottom of the fender to be reversed.

A tensioning device is depicted in FIG. 5c. If the rope is to be used to provide additional compression of the nesting fender elements (i.e. holding the segments, connectors and endcaps together), a tensioning device 56 may be deployed. A cam, cleat, cord lock or threaded tensioner may be coupled with the rope 54. For the aforementioned compression to be provided, tensioning devices or tensioning devices and knots may be coupled along the rope in positions adjacent to the endcap where the rope exits the rope channels (i.e. at points 57a and 57b). The rope may be tightened, pulling any slack out of the length of rope from the tensioning devices and through the two rope channels, enabling the rope to provide the compression of the segments, connectors and endcaps.

Tensioning the rope through the rope channels using tensioning devices may also occur during manufacturing in instances where the elements are adhered together, compressing the elements together after application of an adhesive to permit time for the adhesive to set and bond.

It is noted that the rope disposed through the at least two rope channels, when tightened, provides additional structural integrity to the fender itself, making the fender more impact-resistant, and thus even more suitable as a bumper between a boat and other object such as a dock or another boat. A rebound performance of the fender may even be adjusted, by the user or in manufacturing, through the application or removal of the tensioning devices, facilitating a hard or soft mode of rebound.

As described above with respect to FIGS. 1a-1c, the nesting fender and its elements (i.e. the segments, connectors and endcaps) are manufactured in graduated sizes, enabling smaller fenders to fit inside larger fenders for space-saving. It will be observed that when inserting a smaller fender into the next larger fender, the rope is pushed out of the way of the opening through the top of the fender, providing access for the smaller fender into the interior of the larger fender. The rope can be drawn taut at the bottom of the fender, providing a rigid length of the rope against which the bottom of the smaller fender comes to rest when it is inserted into the larger fender.

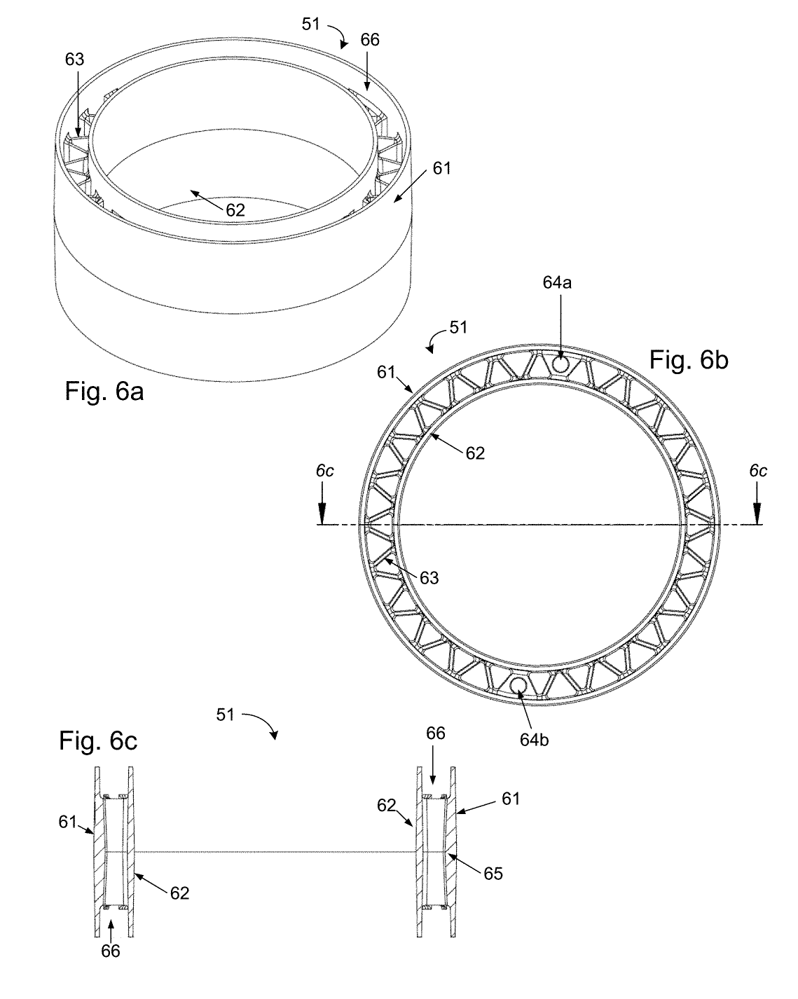

Turning to FIGS. 6a-6c, a segment 51 has an outer wall 61 and an inner wall 62. Disposed within an interior of the segment between the outer and inner walls is an engineered truss 63 structure having a series of spokes joining the outer and inner walls at alternating angles. The alternating-angled spokes form triangular bracing structures defining a support structure between the outer and inner walls, increasing the structural integrity of the segment and the fender of which the segment is a part. It may be seen that the height of the engineered truss does not extend to the top and bottom of the segment; rather, a U channel 66 is formed within the segment at both the top of the segment and the bottom of the segment at the points within the segment where the engineered truss ends. The top and bottom U channels of the segments form a cavity for receiving a mating portion of the connectors. Passages 64a and 64b through the segment, disposed radially opposite to one another, are present to form portions of the rope segments as discussed above to form a cylindrical truss. As is best seen in FIG. 6c, the outer wall 61 may have a bow in the direction of the center of the segment. The bow may be, for example, formed by a one degree angle from the outer wall and inner wall. The additional material which forms the bow has the effect of strengthening the segment against pressure exerted from its top and bottom.

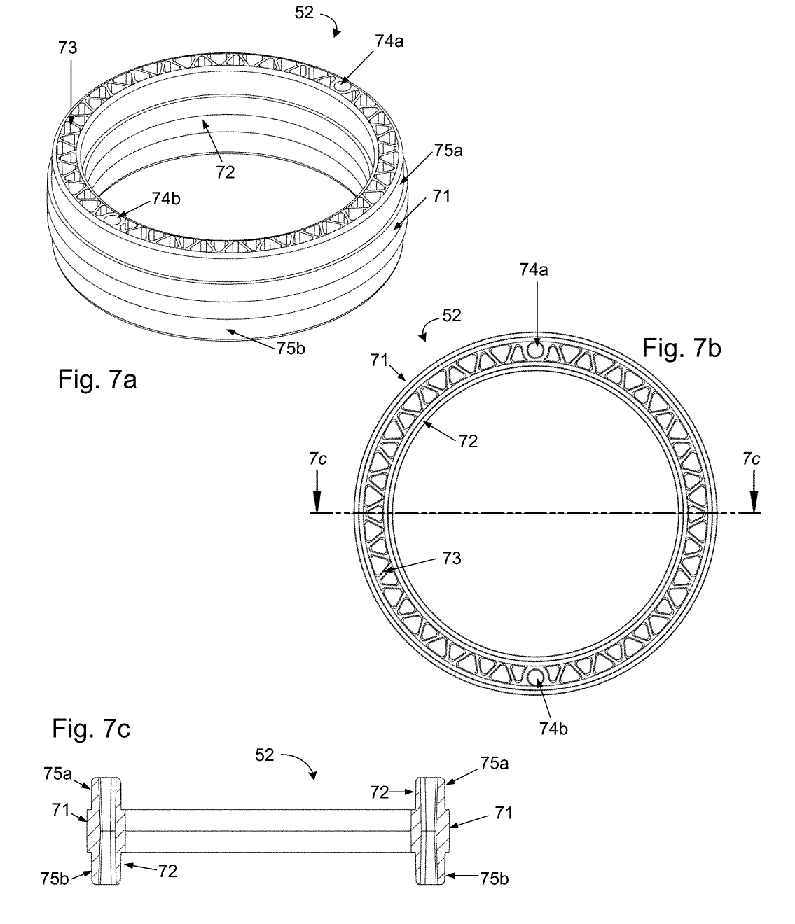

Turning to FIGS. 7a-7c, a connector 52 has an outer wall 71 and an inner wall 72. The top and bottom of the connector each have a raised portion, best seen in FIGS. 7a and 7c. The top raised portion 75a and the bottom raised portion 75b are sized to interlock with the U channels in the segments discussed with respect to FIGS. 6a-6c. Also like the segments, the connectors have an engineered truss 73 defining a support structure between the outer wall 71 and inner wall 72 of the connectors for increased structural integrity of the connector and the fender of which the connector is a part. Passages 74a and 74b through the connector, disposed radially opposite to one another, are present to form portions of the rope channels as discussed above.

It is noted that, at a cross-section of a nested fender where the raised portion of the connector is inserted into the U channel of the segment, eight walls (four of the segment and four of the connector) in addition to portions of the engineered truss of the connector are disposed across a diameter line through the cross-section, providing significant strength and impact-resistance to the fender despite the fender being constructed of a plurality of elements rather than being of a one-piece design.

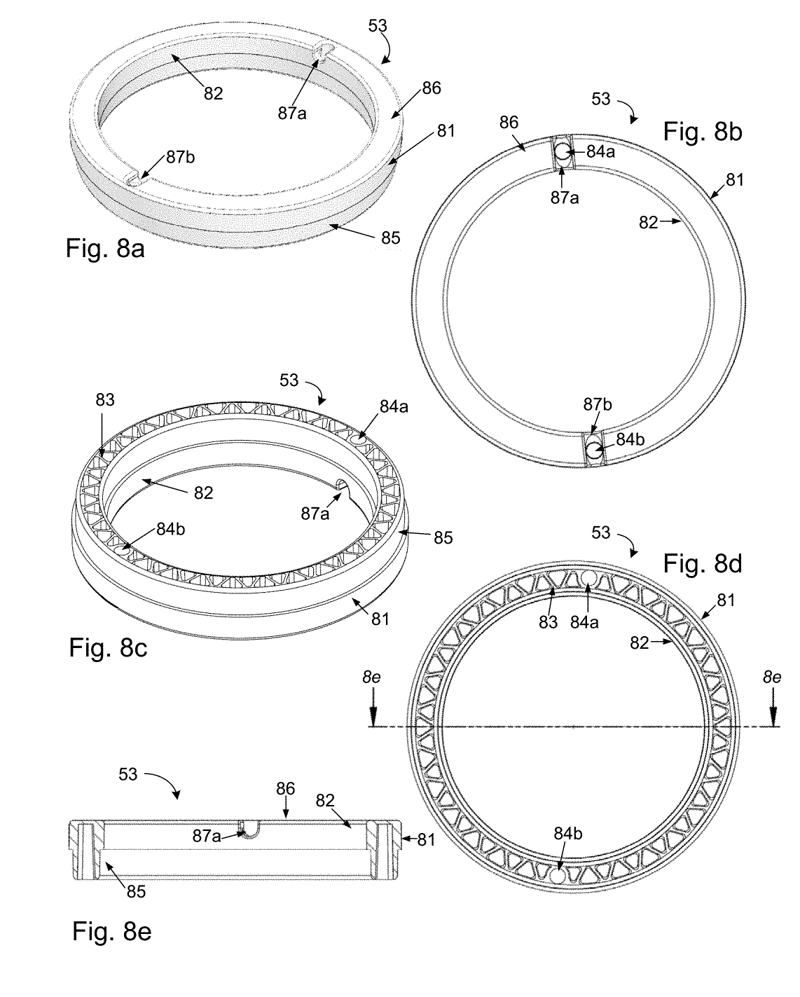

Turning to FIGS. 8a-8e, an endcap 53 has an outer wall 81, an inner wall 82 and a top surface 86. Opposite the top surface is a raised portion 85, similar to the raised portion of the connector discussed with respect to FIGS. 7a-7c except that the endcap only has one raised portion. Like those of the connector, the raised portion of the endcap is sized to interlock with a U channel of a segment discussed with respect to FIGS. 6a-6c. Also like the segments and the connectors, an engineered truss 83 defines a support structure between the outer wall and inner wall of the endcap for increased structural integrity of the endcap and the fender of which the endcap is a part. Passages 84a and 84b through the endcap, disposed radially opposite to one another, are present to form portions of the rope channels as discussed above. The passages through the endcap terminate in rope outlets 87a and 87b located adjacent to, but not flush with, the top surface of the endcap. Particularly, the apertures at the ends of the passages are disposed below (i.e. are offset from) the top surface of the endcap. A cutout through the inner wall of the endcap adjacent to the apertures at the ends of the passages permits the rope to pass, once leaving the rope channel, towards the interior of the fender. In this way, the design of the rope outlet involving the cutout through the inner wall proximate to the ends of the rope channels permits the fender to sit flat on its end on the ground without the rope, a knot, or accessory attachment being in the way.

It is noted that the endcaps are an optional component of the nesting fender, and that a nesting fender may be constructed only of segments and connectors. Use of the endcap provides benefits including the aforementioned facility of the fender resting on its end on the ground; prevention of debris from entering the interior of the nesting fender (e.g. preventing insects or spiders from nesting within the nesting fender); and/or sealing of the interior of the nesting fender against entry by water, providing air pockets within the nesting fender which may assist in its functional performance and/or cause it to float. For those reasons one or more endcaps may be desired, but the nesting functionality of the fender is not lost if the endcaps are not employed. It is also noted that the endcap at the top of the nesting fender is a common part to the endcap at the bottom of the nesting fender, providing greater economies in manufacturing than if a unique top and bottom endcap was required.

In some embodiments, additional channels disposed through the segments, connectors and endcaps may be provided for receiving additional elements intended to strengthen and/or change the performance of the nesting fender. For example, vertical battens or dowels made of wood, metal, ceramic, glass or plastic could be disposed through the additional channels provided through the nesting fenders. Such additional channels could be equally spaced around the fender, for example, every 60 or 90 degrees permitting six or four dowels to be present. In this manner, the battens or dowels could spread a point load resulting from an impact at a particular location on the nesting fender along the entire height of the fender. The impact-resistance characteristics resulting from the deployment of the dowels or battens may be modified through the use of the length, shape or girth of the dowels or battens themselves, through the amount of friction between the dowels or battens and the channels, through the use of adhesive along some or all of the length of the dowels or battens, as well as through the number of dowels or battens in use. The dowels or battens can be various shapes, including flat, cylindrical, or truss-shaped similar to the engineered truss within the segments, connectors and endcaps.

In some embodiments, the segments and connectors would have passages forming channels for the dowels or battens, but the endcaps would be enclosed at the points where the dowels or battens would otherwise exit the top surface of the endcaps. In different embodiments, the endcaps would also have passages disposed from the bottom of the raised portion through the top surface, allowing a dowel or batten to be inserted into the nesting fender and capped or tensionally adjusted similar to the manner in which a rope tension could be adjusted using a tensioning device, as described with respect to FIGS. 5a-5c. The tensional aspect of the dowels or battens could thus be set at time of manufacturing of the nesting fender, or could alternatively be controlled by a user as needed to achieve a particular rebound performance (hard or soft, e.g.) of the fender. In some embodiments, a rope can be attached to the dowels or battens or the tensioning devices.

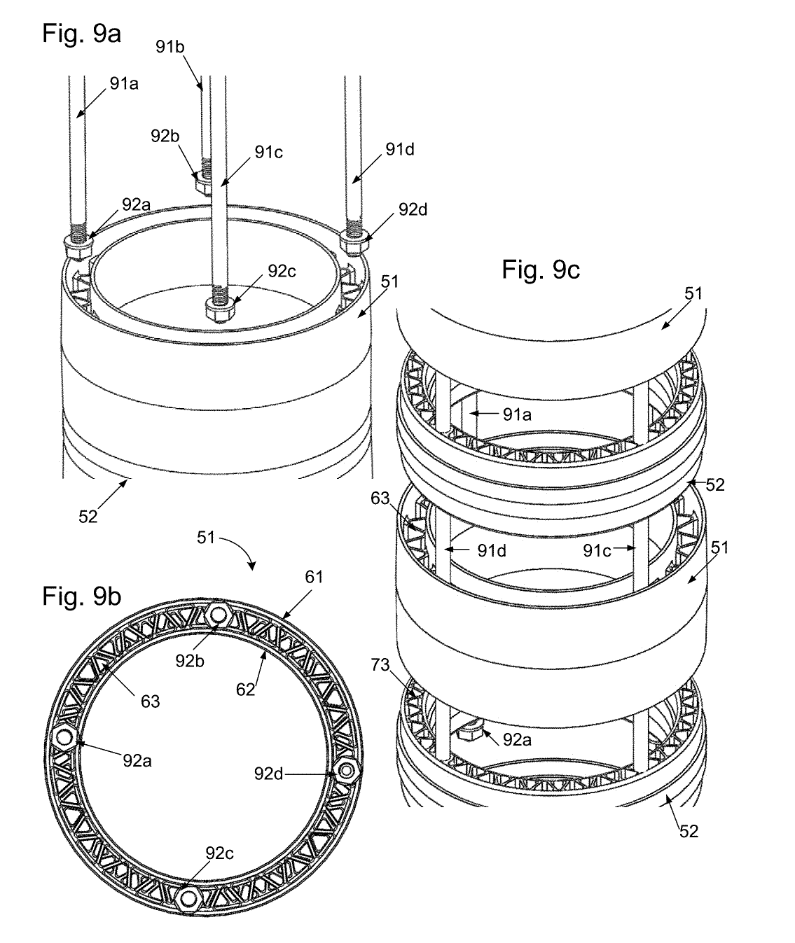

Turning to FIGS. 9a-9c, then, depicted is a plurality of battens 91. In the exemplary embodiment shown, the battens are cylindrical and have threads at each end. Exemplary threaded tension adjustment nuts 92 are provided. In the depicted exemplary embodiment in which endcaps have not been implemented, the battens are passed through the gaps in the engineered truss 63 between the outer wall 61 and the inner wall 62 of the segments, the gaps being spaces between the spokes of the engineered truss, the gaps running from the top to the bottom of the engineered truss. The battens also pass through gaps in the engineered truss 73 of the connectors, the gaps of the segments being disposed similarly to those of the connectors. Upon the battens passing through all the segments and connectors and exiting the top or bottom of the nesting fender, the threaded tension adjustment nuts may be threadably coupled with the battens and tightened as desired to affect the rebound performance of the fender as described above.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A nesting fender, comprising:
at least two segments;
at least one connector; and
a rope.

2. The nesting fender of claim 1, wherein each of the at least two segments and the at least one connector include at least two passages.

3. The nesting fender of claim 2, wherein the at least two passages of each of the at least two segments and the at least one connector are alignable to form at least two rope channels.

4. The nesting fender of claim 3, wherein the rope is passed through the at least two rope channels and a first end of the rope and a second end of the rope are joined after the rope is passed through the at least two rope channels.

5. The nesting fender of claim 1, wherein each of the at least two segments includes at least an outer wall, an inner wall, and an engineered truss disposed between the outer wall and the inner wall.

6. The nesting fender of claim 1, wherein each of the at least two segments includes a U channel proximate to a top portion of a segment and a U channel proximate to a bottom portion of the segment.

7. The nesting fender of claim 6, wherein a U channel is formed through an engineered truss disposed between the outer wall and the inner wall having a height that does not extend to match a full height of an inner wall and an outer wall of a segment.

8. The nesting fender of claim 6, wherein a U channel is configured for receiving a raised portion of a connector.

9. The nesting fender of claim 1, wherein the at least one connector includes at least an outer wall, an inner wall, and an engineered truss disposed between the outer wall and the inner wall.

10. The nesting fender of claim 1, wherein the at least one connector includes at least a raised portion configured for fitting into a U channel of a connector.

11. The nesting fender of claim 1, further comprising at least one endcap.

12. The nesting fender of claim 11, wherein the at least one endcap includes at least two rope outlets, the at least two rope outlets offset from a top surface of the at least one endcap.

13. The nesting fender of claim 12, wherein the at least one endcap includes two cutouts through an inner wall of the at least one endcap, each of the two cutouts disposed proximate adjacent to two corresponding apertures located at each of two ends of two passages disposed through the at least one endcap.

14. The nesting fender of claim 13, wherein the at least one endcap includes at least an outer wall, an inner wall, and an engineered truss disposed between the outer wall and the inner wall.

15. The nesting fender of claim 12, wherein the at least one endcap includes at least two passages, each of the at least two passages beginning at apertures at the at least two rope outlets.

16. The nesting fender of claim 1, wherein the at least two segments and the at least one connector are held together via frictional tension.

17. The nesting fender of claim 16, wherein the frictional tension is created by insertion of a top raised portion of the at least one connector being inserted into a U channel of a first segment and by insertion of a bottom raised portion of the at least one connector being into a U channel of a second segment.

18. The nesting fender of claim 1, further comprising at least two adhesive film rings.

19. A nesting fender of claim 1, wherein channels are disposed through the segments.

20. A nesting fender of claim 19, wherein battens or dowels or other elements are placed in the channels with or without adhesive to change the performance of the nesting fender.

21. A nesting fender of claim 20, wherein the battens or dowels or other elements can be put under adjustable tension with a tensioning device to change the performance of the nesting fender.

22. A nesting fender of claim 20, wherein the tensioning devices are hidden by the cap.

23. A nesting fender of claim 20, wherein the tensioning devices are visible on top of the cap.

24. A nesting fender arrangement, comprising:
a first nesting fender, including at least:
a cylindrical body, including at least:
at least two segments; and
at least one connector;
an interior cavity, the interior cavity including at least an annular shape with a top aperture, the top aperture leading to the interior cavity through a top surface of the cylindrical body; and
a rope disposed through a first and a second rope channel disposed through the at least two segments and the at least one connector; and
at least one other fender, the at least one other fender including at least a cylindrical body diameter that is substantially the same as an interior cavity diameter of the first fender.

25. A nesting fender arrangement, comprising:
a first nesting fender, including at least:
a cylindrical body, including at least:
at least two segments; and
at least one connector;
an interior cavity, the interior cavity including at least an annular shape with a top aperture, the top aperture leading to the interior cavity through a top surface of the cylindrical body; and
a rope disposed through a first and a second rope channel disposed through the at least two segments and the at least one connector; and
at least one other fender, the at least one other fender including at least a cylindrical body diameter that is substantially the same as an interior cavity diameter of the first fender, the at least one other fender capable of being retained at least partially within the first nesting fender by the rope.
